(19) United States
(12) Patent Application Publication
(10) Pub. No.: US 2025/0132342 A1
(43) Pub. Date: Apr. 24, 2025

(54) ALL-SOLID-STATE RECHARGEABLE BATTERY

(71) Applicant: SAMSUNG SDI CO., LTD., Yongin-si (KR)

(72) Inventors: Satoshi FUJIKI, Yongin-si (KR); Hiroe Ishihara, Yongin-si (KR); Yuichi Aihara, Yongin-si (KR)

(21) Appl. No.: 19/007,191

(22) Filed: Dec. 31, 2024

Related U.S. Application Data
(63) Continuation of application No. 17/582,313, filed on Jan. 24, 2022.

(30) Foreign Application Priority Data
Feb. 3, 2021 (JP) 2021-016112
Jun. 28, 2021 (KR) 10-2021-0084111

(51) Int. Cl. H01M 4/62; H01M 4/02; H01M 4/133; H01M 10/0525

(52) U.S. Cl. CPC H01M 4/622; H01M 4/133; H01M 10/0525; H01M 2004/028

(57) ABSTRACT

An all-solid-state rechargeable battery including a positive electrode layer; a negative electrode layer; and a solid electrolyte layer between the positive electrode layer and the negative electrode layer, wherein the positive electrode layer includes a plate-shaped positive electrode current collector, and a positive electrode active material layer on the positive electrode current collector, the positive electrode layer includes an endothermic material that absorbs heat by a decomposition reaction, and a content of the endothermic material in the positive electrode layer is greater than or equal to about 1 part by weight and less than or equal to about 30 parts by weight, based on 100 parts by weight of the positive electrode active material layer.

### CROSS-REFERENCE TO RELATED APPLICATIONS

This is a continuation application based on pending application Ser. No. 17/582,313, filed Jan. 24, 2022, the entire contents of which is hereby incorporated by reference.

This application claims priority to and the benefit of Japanese Patent Application No. 2021-016112 filed in the Japanese Patent Office on Feb. 3, 2021, and Korean Patent Application No. 10-2021-0084111 filed in the Korean Intellectual Property Office on Jun. 28, 2021, the entire contents of both being incorporated herein by reference.

### BACKGROUND

### 1. Field

Embodiments relate to an all-solid-state rechargeable battery.

### 2. Description of the Related Art

All-solid-state rechargeable batteries may have higher safety than rechargeable batteries using an organic electrolyte solution, and may generate oxygen when placed under a high temperature environment of 200° C. or higher and the like or depending on a composition of a positive electrode active material.

### SUMMARY

The embodiments may be realized by providing an all-solid-state rechargeable battery including a positive electrode layer; a negative electrode layer; and a solid electrolyte layer between the positive electrode layer and the negative electrode layer, wherein the positive electrode layer includes a plate-shaped positive electrode current collector, and a positive electrode active material layer on the positive electrode current collector, the positive electrode layer includes an endothermic material that absorbs heat by a decomposition reaction, and a content of the endothermic material in the positive electrode layer is greater than or equal to about 1 part by weight and less than or equal to about 30 parts by weight, based on 100 parts by weight of the positive electrode active material layer.

The endothermic material may be included in the positive electrode active material layer, or included in a layer between the positive electrode active material layer and the positive electrode current collector.

The endothermic material may include a carbonate compound or a hydroxide compound.

The endothermic material may include the carbonate compound, and the carbonate compound may include lithium carbonate.

The endothermic material may include the hydroxide compound, and the hydroxide compound may include aluminum hydroxide.

The solid electrolyte layer may include a sulfide solid electrolyte.

The all-solid-state rechargeable battery may further include an exterior body accommodating the positive electrode layer, the negative electrode layer, and the solid electrolyte layer therein, the exterior body being a film type.

A difference between a volume contained within the exterior body at 80° C. and a volume contained within the exterior body at 25° C. is within about 5% of the volume contained within the exterior body at 25° C.

The endothermic material may include aluminum oxide hydrate, barium nitrate hydrate, calcium sulfate hydrate, cobalt phosphate hydrate, antimony oxide hydrate, tin oxide hydrate, titanium oxide hydrate, bismuth oxide hydrate, or tungsten oxide hydrate.

### BRIEF DESCRIPTION OF THE DRAWINGS

Features will be apparent to those of skill in the art by describing in detail exemplary embodiments with reference to the attached drawings in which:

FIG. 1 is a cross-sectional view of a schematic configuration of an all-solid-state rechargeable battery according to an embodiment.

FIG. 2 is a cross-sectional view of a schematic configuration of an all-solid-state rechargeable battery according to another embodiment.

FIG. 3 is a cross-sectional view of a schematic configuration of an all-solid-state rechargeable battery according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

### 1. Basic Configuration of All-solid-state Rechargeable Battery According to the Present Embodiment

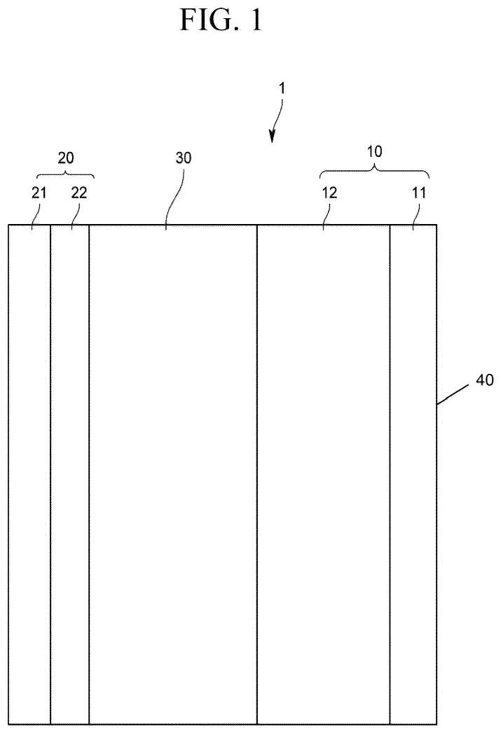

As shown in FIG. 1, the all-solid-state rechargeable battery 1 according to the present embodiment may include a positive electrode layer 10, a negative electrode layer 20, and a solid electrolyte layer 30. In an implementation, an exterior body may accommodate elements of the all-solid-state rechargeable battery 1 therein.

### (1-1. Positive Electrode Layer)

The positive electrode layer 10 may include a positive electrode current collector 11 and a positive electrode active material layer 12. Examples of the positive electrode current collector 11 may include a plate or thin body made of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. As used herein, the term “or” is not an exclusive term, e.g., “A or B” would include A, B, or A and B. In an implementation, the positive electrode current collector 11 may be omitted. The positive electrode active material layer 12 may include a positive electrode active material and a solid electrolyte. In an implementation, the solid electrolyte contained or included in the positive electrode active material layer 12 may or may not be of the same type as the solid electrolyte of the solid electrolyte layer 30. The details of the solid electrolyte will be described in detail in the section of the solid electrolyte layer 30.

The positive electrode active material may be a suitable positive electrode active material capable of reversibly intercalating and deintercalating lithium ions. In an implementation, the positive electrode active material may include, e.g., a lithium salt or compound (such as lithium cobalt oxide (hereinafter referred to as “LCO”), lithium nickel oxide, lithium nickel cobalt oxide, and lithium nickel cobalt aluminate (hereinafter referred to as “NCA”), lithium nickel cobalt manganate (hereinafter referred to as “NCM”), lithium manganate, lithium iron phosphate); nickel sulfide, copper sulfide, lithium sulfide, sulfur, iron oxide; vanadium oxide, or the like. These positive electrode active materials may be used alone, respectively, and may be used in combination of two or more.

In an implementation, the positive electrode active material may be formed by including a lithium salt of a transition metal oxide having a layered rock salt structure among the aforementioned materials. Herein, the “layered rock salt structure” is a structure in which oxygen atomic layers and metal atomic layers are alternately arranged in the <111> direction of the cubic rock salt structure, and as a result, each atomic layer forms a two-dimensional plane. In addition, “cubic rock salt structure” refers to a sodium chloride type structure, which is one type of crystal structure, e.g., a structure in which the face-centered cubic lattice formed by each of the cations and anions is arranged with a shift of only ½ of the corners of the unit lattice from each other.

Examples of the lithium salt of the transition metal oxide having such a layered rock salt structure may include lithium salts of ternary transition metal oxides such as LiNiₓCo_{y}Al_{z}O₂ (NCA) or LiNiₓCo_{y}Mn_{z}O₂ (NCM) (in which 0<x<1, 0<y<1, 0<z<1, and x+y+z=1).

When the positive electrode active material includes a lithium salt of a ternary transition metal oxide having the aforementioned layered rock salt structure, the energy density and thermal stability of the all-solid-state rechargeable battery 1 may be improved.

In an implementation, the positive electrode active material may be covered with a coating layer. The coating layer may be a suitable coating layer of the positive electrode active material of an all-solid-state rechargeable battery. Examples of the coating layer may include Li₂O—ZrO₂ or the like.

In an implementation, when the positive electrode active material is formed from a lithium salt of a ternary transition metal oxide such as NCA or NCM, and nickel (Ni) is included as the positive electrode active material, capacity density of the all-solid-state rechargeable battery 1 may be increased, and metal elution from the positive electrode active material in a charged state may be reduced. Accordingly, the all-solid-state rechargeable battery 1 according to the present embodiment may help improve long-term reliability and cycle characteristics in a charged state. In order to further exhibit such characteristics, a content of nickel (Ni) may be high. In an implementation nickel content in the positive electrode active material may be greater than or equal to about 60 mol %, e.g., greater than or equal to about 80 mol %. In an implementation, the nickel content may be less than or equal to about 95 mol %, with a view toward suppressing a decrease of battery capacity in charge/discharge evaluation.

In an implementation, the positive electrode active material may have a shape of a particle, e.g., a regular spherical shape and an ellipsoidal shape. In an implementation, the particle diameter of the positive electrode active material may be, e.g., within a range suitable for a positive electrode active material of an all-solid-state rechargeable battery. In an implementation, a content of the positive electrode active material in the positive electrode layer 10 may be within a range suitable for the positive electrode layer 10 of an all-solid rechargeable battery. In an implementation, in the positive electrode active material layer 12, in addition to the aforementioned positive electrode active material and solid electrolyte, e.g., additives such as a conductive auxiliary agent, a binder, a filler, a dispersant, or an ion conductive auxiliary agent may be suitably blended.

Examples of the conductive auxiliary agent that may be blended in the positive electrode active material layer 12 may include graphite, carbon black, acetylene black, ketjen black, a carbon fiber, and a metal powder. In an implementation, the binder that may be blended in the positive electrode active material layer 12 may include, e.g., a styrene butadiene rubber (SBR), polytetrafluoroethylene, polyvinylidene fluoride, polyethylene, or the like. In an implementation, as the filler, the dispersant, the ion conductive auxiliary agent, or the like, which may be blended in the positive electrode active material layer 12, suitable materials which may be used for the electrode of an all-solid-state rechargeable battery may be included.

### (1-2. Negative Electrode Layer)

The negative electrode layer 20 may include a negative electrode current collector 21 and a negative electrode active material layer 22. The negative electrode current collector 21 may be made of a material that does not react with lithium, e.g., neither an alloy nor a compound is formed. Examples of the material of the negative electrode current collector 21 may include copper (Cu), stainless steel, titanium (Ti), iron (Fe), cobalt (Co), and nickel (Ni). The negative electrode current collector 21 may be composed of any one of these metals, or may be composed of an alloy of two or more metals or a clad material. The negative electrode current collector 21 may be, e.g., a plate or thin type.

The negative electrode active material layer 22 may include a negative electrode active material. Examples of the negative electrode active material may include a carbon material, e.g., amorphous carbon, and an alloy-forming element that forms an alloy with lithium. The alloy-forming element may include, e.g., gold, platinum, palladium, silicon, silver, aluminum, bismuth, tin, or zinc. The amorphous carbon may include, e.g., carbon black. In an implementation, the carbon may include, e.g., graphene, graphite, or the like. Examples of the carbon black may include acetylene black, furnace black, and ketjen black. In an implementation, in order to help improve electronic conductivity, the surface of silicon may be coated with a carbon layer having a thickness of about 1 nm to about 10 nm.

In an implementation, when gold, platinum, palladium, silicon, silver, aluminum, bismuth, tin, or zinc is used as the alloy-forming element, these negative electrode active materials may be, e.g., in the form of particles and may have a particle diameter of less than or equal to about 4 μm and less than or equal to about 300 nm. In this case, the characteristics of the all-solid-state rechargeable battery 1 may also be improved. Herein, the particle size of the negative electrode active material may be, e.g., an average or median diameter (D50) measured using a laser particle size distribution meter. In an implementation, in the negative electrode active material layer 22, in addition to the above components, additives used in conventional all-solid rechargeable batteries, e.g., a binder, a filler, a dispersant, an ion conductive auxiliary agent, or the like, may be suitably included or blended.

### (1-3. Solid Electrolyte Layer)

The solid electrolyte layer 30 may be between the positive electrode layer 10 and the negative electrode layer 20 and may include a solid electrolyte.

The solid electrolyte may be composed of or include, e.g., a sulfide solid electrolyte material. The sulfide solid electrolyte material may include, e.g., Li₂S—P₂S₅, Li₂S—P₂S—LiX (in which X is a halogen element, e.g., I or CI), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are an integer and Z is Ge, Zn, or Ga), Li₂S—GeS₂, Li₂S—SiS₂—Li₃PO₄, or Li₂S—SiS₂—LiₚMO_{q} (in which p and q are an integer and M is P, Si, Ge, B, Al, Ga, or In). In an implementation, the sulfide solid electrolyte material may be produced by treating a starting raw material (e.g., Li₂S, P₂S₅, or the like) by a melt quenching method, a mechanical milling method, or the like. In an implementation, heat treatment may be further performed. The solid electrolyte may be amorphous or crystalline, or may be in a mixed state thereof.

In an implementation, the solid electrolyte may include sulfur(S), phosphorus (P) and lithium (Li) as constituent elements among the above sulfide solid electrolyte materials, e.g., Li₂S—P₂S₅. In an implementation, when using one containing Li₂S—P₂S₅ as the sulfide solid electrolyte material forming the solid electrolyte, a mixing mole ratio of Li₂S and P₂S₅ may be, e.g., in the range of Li₂S:P₂S₅=about 50:50 to about 90:10.

In an implementation, the solid electrolyte layer 30 may further include a binder. The binder included in the solid electrolyte layer 30 may include, e.g., a styrene butadiene rubber (SBR), polytetrafluoroethylene, polyvinylidene fluoride, polyethylene, or the like. The binder in the solid electrolyte layer 30 may be the same as or different from the binder in the positive electrode active material layer 12 and the negative electrode active material layer 22.

### (1-4. Exterior Body)

The exterior body may accommodate the positive electrode layer 10, the negative electrode layer 20, and the solid electrolyte layer 30 therein as described above, and may be, e.g., formed by or of a film having flexibility (e.g., as a pouch). Examples of the film may include a laminate film formed by sandwiching a thin metal film such as aluminum or SUS with a resin such as polypropylene or polyethylene. A thickness of the laminated film used for the exterior body 40 may be greater than or equal to about 30 μm and less than or equal to about 150 μm. Other materials may be rigid metals. In an implementation, a can formed of aluminum, SUS, or the like may be used. The shape of the exterior body may be, e.g., square (rectangular) or cylindrical.

### 2. Characteristic Configuration of All-solid-state Rechargeable Battery According to the Present Embodiment

The positive electrode active material layer 12 may include an endothermic material, e.g., a material that absorbs heat by undergoing a decomposition reaction. Examples of the endothermic material may include a carbonate compound, a hydroxide compound, and a compound containing crystallized water (e.g., a hydrate compound). Examples of the carbonate compound may include a carbonate and a bicarbonate. In an implementation, the carbonate compound may include lithium carbonate, rubidium carbonate, barium carbonate, cobalt carbonate, iron carbonate, nickel carbonate, zinc carbonate, sodium bicarbonate, potassium bicarbonate, rubidium bicarbonate, cesium bicarbonate, or the like.

Examples of the hydroxide compound may include zinc hydroxide, aluminum hydroxide, cadmium hydroxide, chromium hydroxide, cobalt hydroxide, nickel hydroxide, manganese hydroxide, calcium hydroxide, magnesium hydroxide, zirconium hydroxide, iron hydroxide, and nickel hydroxide.

Examples of the compound containing crystallized water may include aluminum oxide hydrate, barium nitrate hydrate, calcium sulfate hydrate, cobalt phosphate hydrate, antimony oxide hydrate, tin oxide hydrate, titanium oxide hydrate, bismuth oxide hydrate, tungsten oxide hydrate, and the like.

The endothermic material may include one type or multiple types of the aforementioned materials.

A content of the endothermic material may be greater than or equal to about 1 part by weight and less than or equal to about 30 parts by weight, when the total amount of the positive electrode active material layer 12 is 100 parts by weight (e.g., based on 100 parts by weight of the positive electrode active material layer 12). In an implementation, the content of the endothermic material may be greater than or equal to about 5 parts by weight and less than or equal to about 25 parts by weight, e.g., greater than or equal to about 5 parts by weight and less than or equal to about 10 parts by weight.

### 3. Method of Producing All-solid-state Rechargeable Battery According to the Present Embodiment

Next, a method of producing the all-solid-state rechargeable battery 1 according to on the present embodiment is described. The all-solid-state rechargeable battery 1 according to the present embodiment may be produced by respectively producing the positive electrode layer 10, the negative electrode layer 20, and the solid electrolyte layer 30, laminating each layer, and finally covering them with the exterior body.

### (3-1. Production Process of Positive Electrode Layer)

First, the materials (positive electrode active material, endothermic material, binder, and the like) constituting the positive electrode active material layer 12 may be added to a non-polar solvent such as dehydrated xylene to prepare a slurry (the slurry may be a paste and other slurry is also the same). Then, the obtained slurry may be applied on the positive electrode current collector 11 and dried. Then, the positive electrode layer 10 may be produced by pressurizing or pressing the obtained laminate (e.g., performing pressurization using hydrostatic pressure). In an implementation, the pressurization process may be omitted. The positive electrode layer 10 may be produced by pressing/compressing a mixture of materials constituting the positive electrode active material layer 12 in a pellet form, or stretching it in a sheet form. When the positive electrode layer 10 is produced by these methods, the positive electrode current collector 11 may be compressed on the produced pellet or sheet.

### (3-2. Production Process of Negative Electrode Layer)

First, the negative electrode active material layer materials (a negative electrode active material, an alloy-non-forming element, a binder, and the like) constituting the negative electrode active material layer 22 may be added to a polar solvent or a non-polar solvent to prepare a slurry. Then, the obtained slurry may be applied on the negative electrode current collector 21 and dried. Then, the negative electrode layer 20 may be produced by pressurizing the obtained laminate (e.g., performing pressurization using hydrostatic pressure). In an implementation, the pressurization process may be omitted.

### (3-3. Production Process of Solid Electrolyte Layer)

The solid electrolyte layer 30 may be made of a solid electrolyte formed from a sulfide solid electrolyte material. First, the starting materials may be treated by a melt quenching method or a mechanical milling method. In an implementation, when the melt quenching method is used, the starting materials (e.g., Li₂S, P₂S₅, or the like) may be mixed in each predetermined amount and pelletized and then, reacted at a predetermined reaction temperature under vacuum and quenched, preparing a sulfide solid electrolyte material. In an implementation, the reaction temperature of the Li₂S and P₂S₅ mixture may be about 400° C. to about 1,000° C., e.g., about 800° C. to about 900° C. In an implementation, reaction time may be about 0.1 hour to about 12 hours, e.g., about 1 hour to about 12 hours. In an implementation, a quenching temperature of the reactant may be at less than or equal to about 10° C., e.g., less than or equal to about 0° C., and a quenching rate may be about 1° C./sec to about 10,000° C./sec, e.g., about 1° C./sec to about 1,000° C./sec.

In an implementation, when the mechanical milling method is used, the starting materials (e.g., Li₂S, P₂S₅, or the like) are stirred and reacted by using a ball mill or the like, preparing the sulfide solid electrolyte material. In an implementation, the mechanical milling method may use a suitable stirring speed and stirring time. In an implementation, as the stirring speed is fast, the sulfide solid electrolyte material may be produced quickly, and as the stirring becomes longer, a conversion rate of the raw material to the sulfide solid electrolyte material may be increased.

Thereafter, the mixed raw material obtained in the melt quenching method or the mechanical milling method may be heat-treated at a predetermined temperature and pulverized, preparing a particle-shaped solid electrolyte. When the solid electrolyte has a glass transition point, it may be changed from amorphous to crystalline through the heat treatment.

In an implementation, the solid electrolyte obtained in the aforementioned method may be formed into the solid electrolyte layer 30 by a suitable film-forming method, e.g., an aerosol deposition method, a cold spray method, a sputtering method, or the like. In an implementation, the solid electrolyte layer 30 may be produced by pressing solid electrolyte particles group. In an implementation, the solid electrolyte layer 30 may be formed by mixing the solid electrolyte, a solvent, and a binder and then, coating and drying the mixture.

(3-4. Assembly Process of All-solid-state Rechargeable Battery)

The positive electrode layer 10, the negative electrode layer 20, and the solid electrolyte layer 30 formed in the above method may be laminated and sandwiched together and then, covered with a laminate film forming the exterior body and pressed (e.g., pressed with a hydrostatic pressure), producing the all-solid-state rechargeable battery 1 according to the present embodiment.

### Effects of the Present Embodiment

In the all-solid-state rechargeable battery constructed in this way, the positive electrode active material layer under an oxidizing environment during charging may include the endothermic material, a decomposition reaction of the endothermic material may occur in an appropriate temperature range, and a sufficient endothermic effect may be exhibited.

In an implementation, the content of the endothermic material may be greater than or equal to about 1 part by weight and less than or equal to about 30 parts by weight, and it is possible to sufficiently exhibit the endothermic effect while sufficiently securing charging capacity of the positive electrode active material layer 12.

### 5. Another Embodiment

<5-1. Configuration of All-solid-state Rechargeable Battery According to the Second Embodiment>

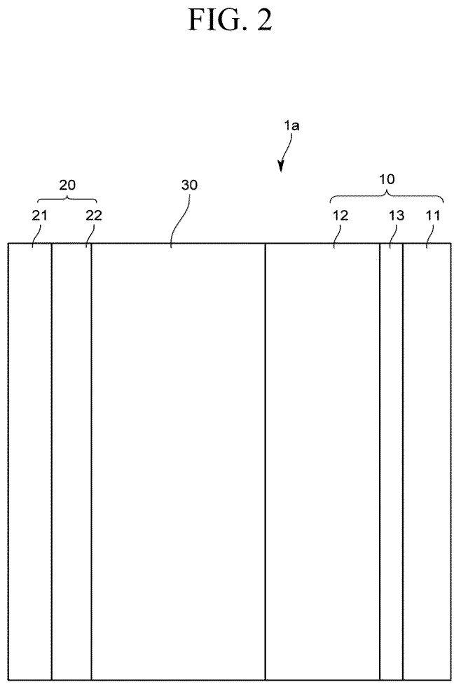

As shown in FIG. 2, the positive electrode layer 10 may further include a conductive layer 13 between the positive electrode current collector 11 and the positive electrode active material layer 12. The conductive layer 13 may help protect the positive electrode current collector, and may include, e.g., a conductive material and a binder.

In an implementation, the conductive material included in the conductive layer 13 may include, e.g., graphite, carbon black, acetylene black, ketjen black, a carbon fiber, a metal powder, or the like. In an implementation, the binder included in the conductive layer 13 may include, e.g., a styrene butadiene rubber (SBR), polytetrafluoroethylene, polyvinylidene fluoride, or polyethylene. In an implementation, the conductive layer 13 may also include the aforementioned endothermic material. In an implementation, when the endothermic material is included, the conductive layer 13 may have, e.g., a specific composition of greater than or equal to about 6 wt % and less than or equal to about 54 wt % of the conductive material, greater than or equal to about 24 wt % and less than or equal to about 81 wt % of the endothermic material, and greater than or equal to 10 wt % and less than or equal to 40 wt % of the binder.

The content of the endothermic material included in the conductive layer 13, or a total content of the endothermic material included in the positive electrode active material layer 12 and endothermic material included in the conductive layer 13 may be greater than or equal to about 1 part by weight and less than or equal to about 30 parts by weight, when the total weight of the positive electrode active material layer 12 is 100 parts by weight (e.g., based on 100 parts by weight of the positive electrode active material layer 12). In an implementation, the endothermic material may be included in both the positive electrode active material layer 12 and the conductive layer 13 or in the conductive layer 13 alone.

In the present embodiment, like the aforementioned embodiment, sufficient endothermic effects may be obtained by using greater than or equal to about 1 part by weight of the endothermic material, when the total weight of the positive electrode active material layer 12 is 100 parts by weight. In addition, when the content of the endothermic material is less than or equal to about 30 parts by weight, a thickness of the conductive layer 13 may be reduced, while conductivity of the conductive layer 13 is maintained, resultantly, suppressing or reducing a volume increase of the all-solid-state rechargeable battery 1a. In an implementation, the thickness of the conductive layer may be greater than or equal to about 0.5 μm and less than or equal to about 10 μm, e.g., greater than or equal to about 1 μm and less than or equal to about 5 μm. In an implementation, the conductive layer 13 containing the endothermic material may exhibit endothermic effects and thus may be referred to as an endothermic layer.

<5-2. Method for Producing All-solid-state Rechargeable Battery According to the Second Embodiment>

Next, a method of producing the all-solid-state rechargeable battery 1a according to second embodiment is described. In the producing process of the positive electrode layer 10 of the all-solid-state rechargeable battery 1a according to the present embodiment, the materials (a conductive material, an endothermic material, a binder, and the like) constituting the conductive layer 13 may be added to a non-polar solvent to form a slurry, and the slurry may be applied on the positive electrode current collector 11 and dried to form the conductive layer 13. On this conductive layer 13, the slurry for forming the positive electrode active material layer 12 may be applied and dried to form the positive electrode active material layer 12, and pressurized to produce the positive electrode layer 10. The other processes may be performed similarly to the first embodiment to produce the all-solid-state rechargeable battery 1a.

<Configuration of All-solid-state Rechargeable Battery According to the Third Embodiment>

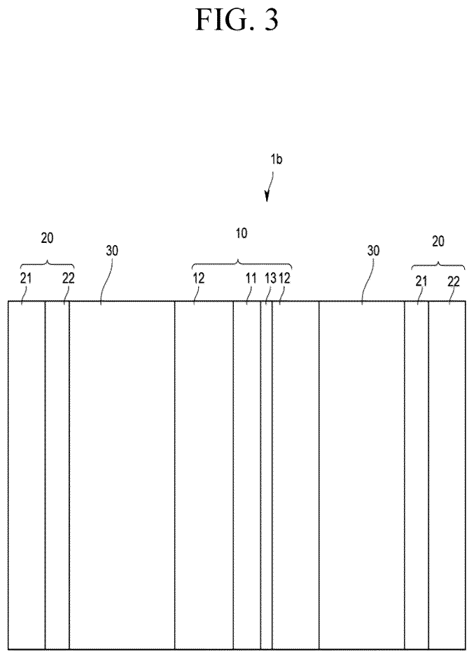

In the aforementioned embodiment, the all-solid-state rechargeable battery 1 having one each of the positive electrode layer 10, the negative electrode layer 20, and the solid electrolyte layer 30 is described, but as shown in FIG. 3, the all-solid-state rechargeable battery 1b may be configured, e.g., by disposing the solid electrolyte layer 30 on both surfaces of the positive electrode layer 10 and the negative electrode layer 20 on the outsides of these solid electrolyte layers 30.

Even in the case of the all-solid-state rechargeable battery 1b having such a configuration, the conductive layer 13 may be between the positive electrode current collector 11 and the positive electrode active material layer 12. The conductive layer 13 may not necessarily be on both surfaces of the positive electrode current collector 11, and as shown in FIG. 3, the conductive layer 13 may be on only one surface of the positive electrode current collector 11. In addition, the endothermic material may be included in the positive electrode active material layer 12 and/or the conductive layer 13 of the all-solid-state rechargeable battery 1b.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### [Production of Positive Electrode Layer]

LiNi_{0.8}Co_{0.15}Al_{0.05}O₂ (NCA) ternary powder (as a positive electrode active material), Li₂S—P₂S₅ (80:20 mol %) amorphous powder (as a sulfide solid electrolyte), and vapor grown carbon fiber powder (as a conductive material, e.g., a conductive auxiliary agent) of a positive electrode layer were weighed in a weight ratio of 60:35:5 and mixed with a rotating/revolving mixer to form a mixed powder. Then, 5 parts by weight of lithium carbonate (based on 100 parts by weight of the mixed powder) was added thereto and then, mixed with the rotating/revolving mixer. Subsequently, a dehydrated xylene solution in which SBR as a binder is dissolved was added to be 5.0 wt %, based on the total weight of the mixed powder including the endothermic material (lithium carbonate), preparing a primary mixed solution. The primary mixed solution had the same amount of a solid content excluding the solvent of the dehydrated xylene solution and the like as that of a positive electrode active material layer, in the present example, and 4.5 wt % of the endothermic material (lithium carbonate) was included, based on the total weight of the positive electrode active material layer.

Then, an appropriate amount of dehydrated xylene for adjusting viscosity was added to the primary mixed solution, preparing a secondary mixed solution. Furthermore, in order to improve dispersibility of the mixed powder, zirconia balls with a diameter of 5 mm were put into the secondary mixed solution so that the mixed powder, the zirconia balls, and spaces respectively took ⅓ of a total volume of a kneading vessel. Subsequently, a tertiary mixed solution produced therefrom was put into the rotating/revolving mixer and stirred at 3,000 rpm for 3 minutes, preparing a positive electrode active material layer coating solution.

Subsequently, after preparing a 20 μm-thick aluminum foil current collector as a positive electrode current collector, the positive electrode current collector was mounted on a desktop screen printing machine, and the positive electrode active material layer coating solution was coated on the sheet by using a metal mask with a size of 2.0 cm×2.0 cm and a thickness of 150 μm. The sheet coated with the positive electrode active material layer coating solution was dried on a 60° C. hot plate for 30 minutes and then, vacuum-dried at 80° C. for 12 hours. Accordingly, on the positive electrode current collector, a positive electrode active material layer was formed. After the drying, the positive electrode current collector and the positive electrode active material layer had a total thickness of about 165 μm.

### [Production of Negative Electrode Layer]

Graphite powder (vacuum-dried at 80° C. for 24 hours) as a negative electrode active material and PVDF as a binder were weighed in a weight ratio of 95.0:5.0.Subsequently, this mixture and an appropriate amount of N-methyl-2-pyrrolidone (NMP) were put in a rotating/revolving mixer and then, stirred at 3,000 rpm for 3 minutes and foam-removed for 1 minute, preparing a negative electrode active material layer coating solution. After preparing a 16 μm-thick copper foil current collector as a negative electrode current collector, the negative electrode active material layer coating solution was applied on the copper foil current collector by using a blade. The negative electrode active material layer coating solution on the copper foil current collector had a thickness of about 150 μm. The sheet coated with the negative electrode active material layer coating solution was placed in a drier heated to 80° C. and dried for 15 minutes. In addition, after the drying, the sheet was vacuum-dried 80° C. for 24 hours. Accordingly, a negative electrode layer was formed. The negative electrode layer had a thickness of about 140 μm.

### [Production of Solid Electrolyte Layer]

A dehydrated xylene solution in which SBR is dissolved was added to Li₂S—P₂S₅ (a mole ratio of 80:20) amorphous powder (as a sulfide solid electrolyte) so that 2.0 wt % of SBR was included, based on the total weight of the amorphous powder, preparing a primary mixed solution. In addition, an appropriate amount of dehydrated xylene for adjusting viscosity was added to this primary mixed solution, preparing a secondary mixed solution. In addition, in order to improve dispersibility of the primary mixed solution, zirconia balls with a diameter of 5 mm were added thereto so that the primary mixed solution, the zirconia balls, and spaces respectively took ⅓ of a total volume of a kneading vessel, preparing a third mixed solution. The third mixed solution prepared therefrom was put in the rotating/revolving mixer and then, stirred at 3,000 rpm, preparing an electrolyte layer coating solution. After loading the negative electrode layer on the desktop screen printing machine, the electrolyte layer coating solution was coated on the negative electrode active material layer by using a 500 μm metal mask. Subsequently, the sheet coated with the electrolyte layer coating solution was dried on a 40° C. hot plate for 10 minutes and then, vacuum-dried at 40° C. for 12 hours. Accordingly, on the negative electrode layer, a solid electrolyte layer was formed. After the drying, the solid electrolyte layer had a total thickness of about 300 μm.

[Production of All-solid-state Battery]

The sheet composed of the negative electrode layer and the solid electrolyte layer was punched into 3.5 cm×3.5 cm, and the positive electrode layer was punched into 3.0 cm×3.0 cm with a Thompson blade and then, laminated with a roll press machine set at a thickness of 150 μm in a dry lamination method, producing a single cell of an all-solid-state battery cell. The cell had a layer thickness of about 400 μm.

[Sealing of All-solid-state Battery]

The produced single cell was placed in an aluminum laminate film equipped with a terminal, evacuated to 100 Pa with a vacuum machine, and then, packed through thermal sealing. The obtained all-solid-state battery cell had a total thickness of about 600 μm.

### [Evaluation of Battery Characteristics]

The single cell was measured with respect to capacity (mAh) by using a charge/discharge evaluation device (TOSCAT-3100) made by Toyo System Inc. Herein, charges and discharges of the cell were performed under an environment of 60° C. The capacity of the single cell was measured by performing the charges up to 4.20 V at a current of 0.1 mA, and the discharges down to 2.50 V at a current of 0.1 mA.

### [Warming Experiment]

The all-solid-state battery cell was charged up to 4.20 V and stored in an 80° C. thermostat for 24 hours. Before and after the storage, a thickness change of the battery cell was measured. In the battery cell enclosed in the laminate bag in this example, a thickness change ratio exhibited a total volume change ratio of the battery cell as it was.

### [DSC Experiment]

The battery cell was charged up to 4.20 V, and then, a DSC sample was prepared in a glove box under an Ar atmosphere according to the following procedure. The single cell was taken out from the laminate bag (which is an exterior body) and then, punched to have a hole with a diameter of 2.5 mm. The punched single cell was put in a sample pan made of SUS and set with a cover thereon and then, joined together with a press machine to seal a mouth thereof. This DSC sample was measured with respect to heat capacity by using a DSC measuring device (DSC7000X) made by Hitachi High-Tech Science Inc. The heat capacity was measured from room temperature to 500° C. and used to estimate integrated heat capacity. When the integrated heat capacity of Comparative Example 1 is set as 100%, an integrated heat capacity change rate in each evaluation example was approximated as a reduction rate.

### Example 2

A positive electrode layer was formed in the same manner as Example 1 except that the amount of the lithium carbonate added to form the positive electrode active material layer was changed to 10 parts by weight, based on 100 parts by weight of the mixed powder.

### Example 3

A positive electrode layer was formed in the same manner as Example 1 except that the amount of the lithium carbonate added to form the positive electrode active material layer was changed to 1 part by weight, based on 100 parts by weight of the mixed powder.

### Example 4

A positive electrode layer is formed in the same manner as Example 1 except that the amount of the lithium carbonate added to form the positive electrode active material layer was changed to 25 parts by weight, based on 100 parts by weight of the mixed powder.

### Example 5

A positive electrode layer was formed by adding the lithium carbonate not to the positive electrode active material layer but to a conductive layer formed between the positive electrode current collector and the positive electrode active material layer. A specific method of producing this is describe below. Acetylene black as a conductive material for forming the conductive layer, the lithium carbonate, and acid-modified PVDF as a binder were weighed in a weight ratio of 30:40:30. These materials with an appropriate amount of NMP were put into a rotating/revolving mixer and stirred at 3,000 rpm for 5 minutes, preparing a conductive layer coating solution. After mounting a 20 μm-thick aluminum foil on a desktop screen printing machine, the conductive layer coating solution was coated thereon by using a 400 mesh screen. Subsequently, the aluminum foil coated with the conductive layer coating solution was vacuum-dried at 80° C. for 12 hours. Accordingly, on the positive electrode current collector, a conductive layer was formed. After the drying, the conductive layer had a thickness of 15 μm. The conductive layer was adjusted to include 5 parts by weight of the lithium carbonate, based on 100 parts by weight of the mixed powder forming the positive electrode active material layer. On the conductive layer, a positive electrode layer was formed by coating and drying the positive electrode active material layer coating solution in the same manner as in Example 1, except that the lithium carbonate was not included in the positive electrode active material layer. The production procedure of the negative electrode layer and procedure thereafter are the same as Example 1.

### Example 6

A conductive layer was formed in the same manner as Example 5 except that the content of the lithium carbonate in the conductive layer was adjusted to 25 parts by weight, based on 100 parts by weight of the mixed powder forming the positive electrode active material layer.

### Example 7

A positive electrode layer was formed in the same manner as Example 5 except that the positive electrode active material layer coating solution was coated and dried on the opposite surface to the side of the positive electrode current collector where the conductive layer was formed.

### Example 8

A conductive layer was formed in the same manner as Example 7 except that the content of the lithium carbonate in the conductive layer was adjusted to 25 parts by weight, based on 100 parts by weight of the mixed powder forming the positive electrode active material layer.

### Example 9

A positive electrode layer was formed in the same manner as Example 1 except that aluminum hydroxide instead of the lithium carbonate was included in the positive electrode active material layer.

### Example 10

A positive electrode layer is formed in the same manner as Example 9 except that the content of the aluminum hydroxide was changed to 10 parts by weight, based on 100 parts by weight of the mixed powder forming the positive electrode active material layer.

### Example 11

A positive electrode layer was formed in the same manner as Example 9 except that the content of the aluminum hydroxide was changed to 1 part by weight, based on 100 parts by weight of the mixed powder forming the positive electrode active material layer.

### Comparative Example 1

A positive electrode layer was formed in the same manner as Example 1 except that the lithium carbonate was not included in the positive electrode active material layer.

### Comparative Example 2

A negative electrode layer was formed in the same manner as Example 1 except that the lithium carbonate was not included in the positive electrode active material layer, and an amount of 5 parts by weight of the lithium carbonate (i.e., the same amount as used in Example 1) was included in a negative electrode active material layer, based on 100 parts by weight of the mixed powder forming the positive electrode active material layer.

### Comparative Example 3

A solid electrolyte layer was formed in the same manner as Example 1 except that the lithium carbonate was not included in the positive electrode active material layer, and 5 parts by weight (i.e., the same amount as used in Example 1) of the lithium carbonate was included in the solid electrolyte layer, based on 100 parts by weight of the mixed powder forming the positive electrode active material layer.

### Comparative Example 4

A negative electrode layer was formed in the same manner as Comparative Example 2 except that aluminum hydroxide instead of the lithium carbonate was included in the negative electrode active material layer.

### Comparative Example 5

A solid electrolyte layer is formed in the same manner as Comparative Example 3 except that aluminum hydroxide was included instead of the lithium carbonate in the solid electrolyte layer.

### Comparative Example 6

A positive electrode layer was formed in the same manner as Example 1 except that the content of the lithium carbonate in the positive electrode active material layer was changed to 0.3 parts by weight, based on 100 parts by weight of the mixed powder forming the positive electrode active material layer.

### Reference Example 1

As a reference example, a liquid system rechargeable battery cell was produced to contain an endothermic material. Hereinafter, a specific experimental method will be described.

### [Production of Positive Electrode Layer]

NCA ternary powder (as a positive electrode active material) and acetylene black (as a conductive aid) were weighed and mixed in a weight ratio of 97:3 to form a mixed powder. In addition, 1 part by weight of lithium carbonate, based on 100 parts by weight of the mixed powder, was weighed and then, mixed with the mixed powder. Subsequently, an NMP solution in which PVdF as a binder is dissolved was added to this mixed powder so that PVdF was 3.0 wt %, based on the total weight of the mixed powder, producing a primary mixed solution. In addition, an appropriate amount of NMP was added to the primary mixed solution to adjust viscosity, producing a secondary mixed solution. The produced secondary mixed solution was put in a rotating/revolving mixer and stirred at 2,000 rpm for 3 minutes, producing a positive electrode active material layer coating solution. After preparing a 20 μm-thick aluminum foil current collector as a positive electrode current collector, mounting the positive electrode current collector on a desktop screen printing machine, and using a metal mask having a size of 2.0 cm × 2.0 cm and a thickness of 150 μm, the positive electrode active material layer coating solution was coated on the sheet. Subsequently, the sheet coated with the positive electrode active material layer coating solution was dried on a 100° C. hot plate for 30 minutes and then, vacuum-dried at 180° C. for 12 hours. Accordingly, on the positive electrode current collector, a positive electrode active material layer was formed. After the drying, the positive electrode current collector and the positive electrode active material layer had a total thickness of about 120 μm. This obtained laminate was press-molded using a roll press to form a positive electrode layer. The positive electrode layer was punched with a 3.0 cm×3.0 cm Thompson blade.

### [Production of Negative Electrode Layer]

Graphite powder (vacuum-dried at 80° C. for 24 hours) as a negative electrode active material and PVdF as a binder were weighed in a weight ratio of 95.0:5.0. These mixed materials and an appropriate amount of NMP were put in a rotating/revolving mixer, stirred at 3,000 rpm for 3 minutes, and foam-removed for 1 minute, producing a negative electrode active material layer coating solution. After preparing a 16 μm-thick copper foil current collector as a negative electrode current collector, the negative electrode active material layer coating solution was coated on the copper foil current collector by using a blade. The negative electrode active material layer coating solution on the copper foil current collector had a thickness of about 150 μm. The sheet coated with the negative electrode active material layer coating solution was stored in a drying machine heated at 80° C. and dried for 15 minutes. In addition, the sheet after the drying was vacuum-dried at 80° C. for 24 hours. Accordingly, a negative electrode layer was formed. The negative electrode layer had a thickness of about 140 μm. The negative electrode layer was press-molded using a roll press machine. The negative electrode layer was punched using a 3.5 cm × 3.5 cm Thompson blade.

### [Production of Liquid System Lithium Ion Rechargeable Battery]

As for a separator, a porous polyethylene film (thickness: 12 μm) was used. The separator was interposed between the positive electrode layer and the negative electrode layer, forming an electrode structure. This electrode structure was placed in an aluminum laminate film to which a terminal is attached. An electrolyte solution was prepared by mixing ethylene carbonate and dimethyl carbonate in a volume ratio of 3:7 and dissolving lithium hexafluoro phosphate (LiPF₆) at a concentration of 1.3 mol/L in the obtained non-aqueous solvent. The prepared electrolyte solution was injected into the aluminum laminate film and impregnated into the separator. After evacuating to 100 Pa with a vacuum machine, the aluminum laminate film was packed through heat sealing. Accordingly, a liquid system lithium ion rechargeable battery cell was produced.

The cells according to Examples 1 to 11 and Comparative Examples 1 to 6 and the reference example were evaluated, and the results are shown in Table 1.

TABLE 1

| | | | Content of | | Thickness | | |
|---|---|---|---|---|---|---|---|
| | | | endothermic | | change | DSC | |
| | | Layer including | material | Cell | after | Exothermic | Reduction |
| | Endothermic | endothermic | (parts by | capacity | storage at | amount | ratio |
| Sample Nos. | material | material | weight) | (mAh) | 80° C. | (J/cm²) | (%) |
| Example 1 | lithium | positive electrode | 5 | 20.3 | 0.6 | 53748 | 17% |
| | carbonate | active material | | | | | |
| | | layer | | | | | |
| Example 2 | lithium | positive electrode | 10 | 19.4 | 0.6 | 43094 | 33% |
| | carbonate | active material | | | | | |
| | | layer | | | | | |
| Example 3 | lithium | positive electrode | 1 | 19.9 | 1.0 | 61145 | 5% |
| | carbonate | active material | | | | | |
| | | layer | | | | | |
| Example 4 | lithium | positive electrode | 25 | 16.5 | 1.0 | 11135 | 83% |
| | carbonate | active material | | | | | |
| | | layer | | | | | |
| Example 5 | lithium | conductive layer | 5 | 19.8 | 0.4 | 52274 | 19% |
| | carbonate | | | | | | |
| Example 6 | lithium | conductive layer | 25 | 19.8 | 0.6 | 14225 | 78% |
| | carbonate | | | | | | |
| Example 7 | lithium | conductive layer | 5 | 20.5 | 0.6 | 52177 | 19% |
| | carbonate | on the rear surface | | | | | |
| | | of positive | | | | | |
| | | electrode current | | | | | |
| | | collector | | | | | |
| Example 8 | lithium | conductive layer | 25 | 20.3 | 0.6 | 12890 | 80% |
| | carbonate | on the rear surface | | | | | |
| | | of positive | | | | | |
| | | electrode current | | | | | |
| | | collector | | | | | |
| Example 9 | aluminum | positive electrode | 5 | 19.7 | 0.8 | 54800 | 15% |
| | hydroxide | active material | | | | | |
| | | layer | | | | | |
| Example 10 | aluminum | positive electrode | 10 | 19.4 | 0.4 | 45199 | 30% |
| | hydroxide | active material | | | | | |
| | | layer | | | | | |
| Example 11 | aluminum | positive electrode | 1 | 20.3 | 0.6 | 62481 | 3% |
| | hydroxide | active material | | | | | |
| | | layer | | | | | |
| Comparative | None | — | — | 19.8 | 0.6 | 64401 | — |
| Example 1 | | | | | | | |
| Comparative | lithium | negative electrode | 5 | 19.8 | 0.6 | 64404 | 1% |
| Example 2 | carbonate | active material | | | | | |
| | | layer | | | | | |
| Comparative | lithium | solid electrolyte | 5 | 20.2 | 0.4 | 65244 | −1% |
| Example 3 | carbonate | layer | | | | | |
| Comparative | aluminum | negative electrode | 5 | 20.1 | 0.6 | 64998 | −1% |
| Example 4 | hydroxide | active material | | | | | |
| | | layer | | | | | |
| Comparative | aluminum | solid electrolyte | 5 | 19.2 | 0.8 | 64744 | −1% |
| Example 5 | hydroxide | layer | | | | | |
| Comparative | lithium | positive electrode | 0.3 | 19.4 | 0.4 | 63197 | 1% |
| Example 6 | carbonate | active material | | | | | |
| | | layer | | | | | |
| Reference | lithium | positive electrode | 1 | 19.4 | 32 | | — |
| Example 1 | carbonate | active material | | | | | |
| | | layer | | | | | |

A content of the endothermic material provided in Table 1 indicates an amount of the endothermic material based on 100 parts by weight of the mixed powder for forming a positive electrode active material layer before adding the binder.

Referring to the results of Table 1, Examples 1 to 11, in which greater than or equal to 1 part by weight of lithium carbonate or aluminum hydroxide as the endothermic material, based on 100 parts by weight of the positive electrode active material layer, was included in the positive electrode layer, exhibited clearly high endothermic effects, compared with Comparative Examples 1 to 6. In addition, even when the endothermic material was included in the conductive layer of the positive electrode layer, sufficient endothermic effects were achieved. Examples 1 to 11 provide all-solid-state rechargeable battery cells capable of suppressing sharp exothermicity.

When the content of the endothermic material included in the positive electrode layer was less than or equal to 30 parts by weight based on 100 parts by weight of the positive electrode active material layer, charging capacity of the positive electrode layer was sufficiently maintained. On the other hand, although not described in the aforementioned examples, when about 50 parts by weight of the endothermic material based on 100 parts by weight of the positive electrode active material layer is included, a battery cell may not operate. The reason is that the endothermic material not contributing to lithium ion conductivity or electron conductivity may be excessively included in the positive electrode active material layer.

Herein, in the all-solid-state battery cells according to the examples and the comparative examples, a thickness change thereof exhibited a volume change, wherein as shown in the result of Table 1, the thickness change under an environment of 80° C. was 1% or less compared with that at room temperature (25° C.), which indicates almost no change. On the other hand, the liquid system lithium ion rechargeable battery cell according to the reference example exhibited a very large volume large change of 32% at 80° C. even though the content of the lithium carbonate was 1 part by weight based on 100 parts by weight of the positive electrode active material layer. This result exhibits that in the liquid system rechargeable battery cell, a decomposition reaction of the endothermic material may violently occur at a low temperature of 80° C., and the all-solid-state rechargeable battery cell of the Examples exhibited sufficient endothermic effects at a higher high temperature than 80° C., and in addition, the decomposition of the endothermic material was relatively slow up to a temperature of 80° C. or so, and battery deformation due to volume expansion may be suppressed.

By way of summation and review, oxygen may cause an exothermic reaction with a sulfide solid electrolyte, and all-solid-state batteries may be further heated up and thus may have a risk of being ignited under the presence of flammable substances.

In order to further enhance safety of an all-solid-state rechargeable battery, an all-solid-state rechargeable battery may be capable of suppressing the aforementioned exothermic reaction even in a high-temperature environment such as 200° C. or higher.

In one technique for suppressing exothermicity of the rechargeable batteries, e.g., a liquid system rechargeable battery containing a compound having a decomposition reaction as the endothermic reaction (hereinafter, referred to as an endothermic material) may be used. However, when this endothermic material is actually applied to an all-solid-state rechargeable battery, the decomposition reaction of the endothermic material, e.g., the endothermic reaction, may hardly occur in the all-solid-state rechargeable battery unlike the liquid system rechargeable battery.

In the all-solid-state rechargeable battery according to an embodiment, the positive electrode layer under an oxidizing environment may include endothermic material during charging, the decomposition reaction of the endothermic material may easily occur during charging, and a sufficient endothermic effect may be exhibited even at a temperature of less than 200° C. As a result, with respect to the all-solid-state rechargeable battery, it is possible to prevent rapid heat generation at 200° C. or higher in which oxygen may be generated during charging.

In addition, the content of the endothermic material in the positive electrode layer may be in the range of greater than or equal to about 1 part by weight and less than or equal to about 30 parts by weight when the total weight of the positive electrode active material layer is 100 parts by weight, and while sufficiently ensuring charging capacity of the positive electrode layer, a sufficient endothermic effect may be exhibited.

If the endothermic material is included in the positive electrode active material layer or in a layer between the positive electrode active material layer and the positive electrode current collector, the endothermic material may be reliably placed in an oxidizing environment during charging.

When the solid electrolyte layer includes a sulfide solid electrolyte, an exothermic reaction could occur when the battery is placed in a high-temperature environment, so that the effects of the present disclosure may be remarkably exhibited.

When an exterior body for accommodating the positive electrode layer, the negative electrode layer, and the solid electrolyte layer therein is further provided, and when the exterior body is a film type, a volume change due to the decomposition reaction of the endothermic material could easily affect an overall volume of the battery, and thus an effect of this disclosure may be exhibited remarkably.

It is possible to further improve safety of the all-solid-state rechargeable battery, suppress the aforementioned exothermic reaction even in a high-temperature environment, and suppress rapid heat generation during charging.

Example embodiments have been disclosed herein, and although specific terms are employed, they are used and are to be interpreted in a generic and descriptive sense only and not for purpose of limitation. In some instances, as would be apparent to one of ordinary skill in the art

as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An all-solid-state rechargeable battery, comprising:
a positive electrode layer;
a negative electrode layer; and
a solid electrolyte layer between the positive electrode layer and the negative electrode layer,
wherein:
the positive electrode layer includes a plate-shaped positive electrode current collector, and a positive electrode active material layer on the positive electrode current collector,
the positive electrode layer includes an endothermic material that absorbs heat by a decomposition reaction, and
the endothermic material includes a carbonate compound or a hydroxide compound.

2. The all-solid-state rechargeable battery as claimed in claim 1, wherein the endothermic material is:
included in the positive electrode active material layer, or
included in a layer between the positive electrode active material layer and the positive electrode current collector.

3. The all-solid-state rechargeable battery as claimed in claim 1, wherein a content of the endothermic material in the positive electrode layer is greater than or equal to about 1 part by weight and less than or equal to about 30 parts by weight, based on 100 parts by weight of the positive electrode active material layer.

4. The all-solid-state rechargeable battery as claimed in claim 1, wherein the carbonate compound includes lithium carbonate.

5. The all-solid-state rechargeable battery as claimed in claim 1, wherein the hydroxide compound includes aluminum hydroxide.

6. The all-solid-state rechargeable battery as claimed in claim 1, wherein the solid electrolyte layer includes a sulfide solid electrolyte.

7. The all-solid-state rechargeable battery as claimed in claim 1, further comprising an exterior body accommodating the positive electrode layer, the negative electrode layer, and the solid electrolyte layer therein, the exterior body being a film type.

8. The all-solid-state rechargeable battery as claimed in claim 7, wherein a difference between a volume contained within the exterior body at 80° C. and a volume contained within the exterior body at 25° C. is within about 5% of the volume contained within the exterior body at 25° C.

9. The all-solid-state rechargeable battery as claimed in claim 1, wherein the endothermic material includes aluminum oxide hydrate, barium nitrate hydrate, calcium sulfate hydrate, cobalt phosphate hydrate, antimony oxide hydrate, tin oxide hydrate, titanium oxide hydrate, bismuth oxide hydrate, or tungsten oxide hydrate.

10. The all-solid-state rechargeable battery as claimed in claim 1, wherein the content of the endothermic material in the positive electrode layer is 5 parts by weight to 30 parts by weight, based on 100 parts by weight of the positive electrode active material layer.

11. The all-solid-state rechargeable battery as claimed in claim 1, wherein the endothermic material does not include an oxide coating.

12. The all-solid-state rechargeable battery as claimed in claim 1, wherein the endothermic material is in contact with the solid electrolyte.

13. The all-solid-state rechargeable battery as claimed in claim 2, wherein:
the endothermic material is included in the positive electrode active material layer,
the positive electrode active material layer includes a mixture of a positive electrode active material and the endothermic material, and
the endothermic material in the mixture of the positive electrode active material layer is in contact with the solid electrolyte.

14. An all-solid-state rechargeable battery, comprising:
a positive electrode layer;
a negative electrode layer; and
a solid electrolyte layer between the positive electrode layer and the negative electrode layer,
wherein:
the positive electrode layer includes a plate-shaped positive electrode current collector, and a positive electrode active material layer on the positive electrode current collector,
the positive electrode active material layer includes a mixture of a positive electrode active material and an endothermic material that absorbs heat by a decomposition reaction, the endothermic material including lithium carbonate.

15. The all-solid-state rechargeable battery as claimed in claim 14, wherein:
a content of the endothermic material in the positive electrode layer is greater than or equal to about 1 part by weight and less than or equal to about 30 parts by weight, based on 100 parts by weight of the positive electrode active material layer.
